(19) United States
(12) Patent Application Publication
(10) Pub. No.: US 2019/0084833 A1
(43) Pub. Date: Mar. 21, 2019

(54) PRODUCTION OF LIQUID HYDROCARBONS, BIOFUELS AND UNCONTAMINATED CO2 FROM GASEOUS FEEDSTOCK

(71) Applicant: EPIPHANY ENERGY CORPORATION, West Vancouver (CA)

(72) Inventors: Michael WEEDON, West Vancouver (CA); Behzad BAHTOOI, Vancouver (CA); Calvin BARTHOLOMEW, Vancouver (CA); Hamid Reza RADFARNIA, Vancouver (CA); Bryan IMBER, Sidney (CA); Debanjan CHAKRABARTI, Sidney (CA)

(21) Appl. No.: 16/075,577

(22) PCT Filed: Feb. 3, 2017
(86) PCT No.: PCT/CA2017/050128

§ 371 Date: Aug. 3, 2018

Related U.S. Application Data
(60) Provisional application No. 62/290,885, filed on Feb. 3, 2016.

(51) Int. Cl. C01B 3/38; C10G 2/00; C10K 1/04; C10K 1/32

(52) U.S. Cl. CPC C01B 3/382; C10G 2/332; C10K 1/04; C10K 1/32; C01B 2203/062; C10G 2300/4081; C01B 2203/0415; C01B 2203/0475; C01B 2203/0495; C01B 2203/0233; C01B 2203/067; C01B 2203/0244

(57) ABSTRACT

There is provided a method for producing hydrocarbon compounds. The method comprising: producing a syngas by introducing a fuel stream comprising a reformable fuel into a reforming system (steam reformer, autothermal reformer, cold plasma reformer and/or internal-reforming fuel cell), and wherein the syngas comprises H₂, CO and CO₂, and has a ratio of [H₂]/[CO] of about 1.4 to about 2.5; producing a decarbonated and dehydrated syngas from the syngas having a ratio of [CO₂]/[CO+CO₂] of no higher than 0.6; performing a Fischer-Tropsch synthesis on the decarbonated and dehydrated syngas in the presence of a cobalt- or iron-based Fischer-Tropsch catalyst, said Fischer-Tropsch catalyst comprising pellets of trilobe, cylindrical, hollow cylinder or spherical construction with diameter about 0.5 mm to about 3.0 mm and aspect ratio of 1 to 3.5, to produce a product stream comprising the hydrocarbon compounds; and recycling aqueous products and/or tail gas.

### FIELD OF INVENTION

The present invention relates to a method of producing hydrocarbon compounds and usable contaminant-free CO₂ from reformable fuels containing short chain hydrocarbons and alcohols. In particular, the invention utilizes either of a combination or standalone use of a variety of synthesis gas production processes (e.g. cold plasma reformer/autothermal reformer/steam methane reformer/fuel cell) and the Fischer-Tropsch synthesis in various configurations.

### BACKGROUND OF THE INVENTION

The Fischer-Tropsch synthesis reaction converts a gas composition comprising H₂ and CO in the presence of a catalyst to hydrocarbon products. The gas stream feed for a Fischer-Tropsch reactor includes products of steam reforming, dry reforming (CO₂ reforming) or autothermal reforming of methane, gasification (partial oxidation) of coal or biomass material, waste gas from other chemical processes, syngas derived from biomass materials including bacteria or anode exhaust gas from fuel cell. Different sources of gas feed for the Fischer-Tropsch reaction produce gas streams with different H₂/CO ratios and different CO₂ levels. As per reaction (1) below, Fischer-Tropsch synthesis consumes 2 moles of hydrogen per 1 mole of carbon monoxide to form —CH₂-blocks and to connect the blocks in longer chains to form hydrocarbon compounds, such as liquid fuel and wax. Where the H₂/CO ratio is greater than 2, reaction (1) favours methane and other gaseous short hydrocarbons. Where the H₂/CO ratio is less than 2 (i.e. sub-stoichiometric conditions), reaction (1) favours formation of longer chain and waxy products while consuming H₂ as a limiting reactant and leaving excess CO in the tail gas. Accordingly, in many known commercial processes, the ratio of H₂/CO in a Fischer-Tropsch feed gas is first adjusted to 2 by a water gas shift reaction or a reverse water gas shift reaction for maximum performance of the Fischer-Tropsch synthesis.

Commercially, Fischer-Tropsch processes are mainly implemented as large scale gas-to-liquids (GLT) plants by oil companies for fuel production while utilizing alternate synthesis gas production processes such as coal gasification. The H₂:CO ratio of the synthesis gas produced from such processes may be much less than 2. However, H₂/CO adjustment via a shift reactor, in a large plant is relatively economical due to the economy of scale, but it is not commercially economical in small to medium applications since the H₂/CO ratio adjustment requires a bigger share of the project budget.

The conventional design of a Fischer-Tropsch synthesis plant is significantly affected by economy of scale. The process is quite expensive in terms of its utility footprint. The design of small to medium scale plants requires more careful integration of the energy and material streams as well as application of alternative technologies to make the process economically viable.

Steam Reforming is a well-established technology for the conversion (reactions 2-4) of hydrocarbons and steam to syngas (CO+H₂) and CO₂. The catalytic reaction system operates with inlet gas temperatures of 600 to 700° C. and outlet temperatures of up to 1000° C., and pressures ranging from atmospheric pressure to 30 bar. Due to the presence of Water Gas Shift equilibrium (reaction 5) in the catalytic system, the H₂:CO ratios can range from 4 to 7 or even higher, depending on the operating conditions. The catalysts for such systems are generally sensitive to contaminants, especially sulfur based impurities.

CH₄+H₂O→CO+3H₂ (2)

CH₄+2H₂O→CO₂+4H₂ (3)

CₙHₘ+nH₂O→nCO+(n+m/2)H₂O (4)

CO+H₂O→CO₂+H₂ (5)

Autothermal Reforming is an adiabatic process that utilizes the energy generated from the partial oxidation of methane (reaction 6) in situ to power the steam methane reforming inside the same catalyst bed. Typically, such systems can be operated to provide H₂:CO ratios close to 2. The catalysts for such systems are generally sensitive to contaminants, especially sulfur based impurities.

CH₄+3/2O₂→CO+2H₂O (6)

Molten Carbonate Fuel Cells (MCFC) utilize H₂ and CO₂/O₂ mixture as anode and cathode side feed respectively, to generate electricity and H₂O and CO₂ as byproducts. The heat generated by oxidation of H₂ to H₂O in the anode can be effectively utilized to couple secondary reactions, such as the steam reforming reaction. This effectively allows the MCFC to operate with the use of a methane as feed gas, instead of H₂. The bi-products from such an operation would contain H₂, CO, CO₂ as well as H₂O.

The operation of cold plasma reformers replaces the catalyst from a conventional autothermal reforming system with a plasma arc. The systems can provide soot free operation, and are not sensitive to the presence of sulfur contaminants in the fuel.

Photosynthetic processes involving designer cyanobacteria (e.g. see U.S. Pat. No. 8,735,651 B2) can be utilized to consume CO₂ and H₂O to produce butanol and/or pentanol, which are valuable as fuels or fuel additives.

No admission is necessarily intended, nor should it be construed, that any of the preceding information constitutes prior art against the present invention.

### SUMMARY OF THE INVENTION

Without limitation, various embodiments of the present invention relate to a method for producing hydrocarbonaceous compounds, the method comprising: (a) producing a syngas by introducing a fuel stream comprising a reformable fuel into a reforming system, wherein the reforming system comprises one or more of a steam reformer, an autothermal reformer, a cold plasma reformer and an internal-reforming fuel cell, and wherein the syngas comprises H₂, CO and CO₂, and has a ratio of [H₂]/[CO] of about 1.4 to about 2.5; (b) producing a decarbonated and dehydrated syngas from the syngas by: (bi) removing CO₂ from the syngas with a carbon capture device; and (bii) removing water from the syngas; wherein (bi) is prior to, simultaneous with or subsequent to (bii); wherein the decarbonated and dehydrated syngas has a ratio of [CO₂]/[CO+CO₂] of no higher than 0.6; (c) performing a Fischer-Tropsch synthesis on the decarbonated and dehydrated syngas under effective Fischer-Tropsch conditions in the presence of a cobalt- or iron-based Fischer-Tropsch catalyst, said Fischer-Tropsch catalyst comprising pellets of trilobe, cylindrical, hollow cylinder or spherical construction with diameter about 0.5 mm to about 3.0 mm and aspect ratio of about 1 to about 3.5, to produce a product stream comprising the hydrocarbon compounds; and (d) separating at least a portion of the hydrocarbon compounds from the product stream to further produce aqueous products and a tail gas comprising H₂, CO₂, H₂O and small chain hydrocarbons. In certain embodiments, the method may further comprise (e) recycling at least a portion of one or both of the aqueous products and the tail gas into one or more of (a), (b) and (c).

In certain embodiments, impurities in the fuel stream entering the reforming system may be reduced by a process comprising sulfur capture, condensing, siloxane polishing and condensate treatment. Sulfur, ammonia and chlorine present in the fuel stream entering the reforming system may be each at less than 30 ppb.

In certain embodiments, the internal-reforming fuel cell may comprise a molten carbonate fuel cell (MCFC) or a solid oxide fuel cell (SOFC). The reforming system may comprise the steam reformer, the autothermal reformer or the cold plasma reformer, in combination with the MCFC or the SOFC. The reforming system may comprise the MCFC or the SOFC without the steam reformer, the autothermal reformer and the cold plasma reformer.

In certain embodiments, the carbon capture device may comprise: a metal oxide stabilized CaO sorbent at a temperature of about 600° C. to about 800° C.; pressure swing adsorption; or a solvent-based absorption process. The metal oxide stabilized CaO sorbent may comprise Zr oxide or an Al oxide.

In certain embodiments, the carbon capture device may comprise the metal oxide stabilized CaO sorbent, and the method may further comprise regenerating the metal oxide stabilized CaO sorbent.

In certain embodiments, the regenerating the metal oxide stabilized CaO sorbent may comprise one or both of: causing a partial vacuum in the carbon capture device using at least a portion of steam produced from the Fischer-Tropsch synthesis or at least a portion of the tail gas at high pressure; and heating and oxidizing at least a portion of the tail gas to produce auxiliary heat, and using the auxiliary heat in the regenerating of the metal oxide stabilized CaO sorbent.

In certain embodiments, the method may further comprise producing one or both of butanol and pentanol from the CO₂ removed in (bi) using bacteria. The bacteria may be photosynthetic cyanobacteria, photosynthetic bacteria, or any bacteria capable of producing biological butanol or biological pentanol, whether by photosynthetic, fermentative or other mechanisms.

In certain embodiments, method step (bii) may comprise condensing out water by cooling the syngas.

In certain embodiments, the method may further comprise heating and oxidizing at least a portion of the tail gas, using heat generated from the cooling of the syngas.

In certain embodiments, the method may further comprise heating the decarbonated and dehydrated syngas prior to (c) using heat generated from the cooling of the syngas.

In certain embodiments, the method may further comprise compressing the decarbonated and dehydrated syngas prior to (c).

In certain embodiments, the hydrocarbon compounds may comprise liquid fuel and wax, and the method may further comprise: separating the wax from other gaseous products of the Fischer-Tropsch synthesis (e.g. but without limitation, in a hot trap); cooling the other gaseous products (e.g. but without limitation, in a cold trap) to condense out the aqueous products comprising water and liquid fuel from the tail gas; and separating the liquid fuel from remaining aqueous products.

In certain embodiments, the method may further comprise recycling at least a portion of the remaining aqueous products into the reforming system.

In certain embodiments, method step (e) may comprise adiabatically depressurizing at least a portion of the tail gas to produce liquid CO₂ and/or dry ice and cooled tail gas comprising unreacted CO and H₂. Method step (e) may further comprise mixing at least a portion of the cooled tail gas with the decarbonated and dehydrated syngas from (b). Method step (e) may further comprise using at least a portion of the cooled tail gas in as a refrigerant to cool one or both of the Fischer-Tropsch synthesis and a cold trap for cooling products downstream of (c).

In certain embodiments, method step (e) may comprise heating and oxidizing at least a portion of the tail gas to produce one or both of auxiliary heat, feed for the reforming system or feed for biofuel synthesis.

In certain embodiments, the method may further comprise using the auxiliary heat in (bi).

In certain embodiments, the Fischer-Tropsch catalyst may be a cobalt-based Fischer-Tropsch catalyst. Alternatively, the catalyst may be an iron-based Fischer-Tropsch catalyst.

In certain embodiments, the syngas produced in (a) may comprise H₂, CO and CO₂, and have a ratio of [H₂]/[CO] of about 1.4 to about 2.0.

Without limitation, various embodiments of the present invention relate to a method for producing hydrocarbonaceous compounds, the method comprising: producing a syngas by introducing a fuel stream comprising a reformable fuel into an internal-reforming fuel cell and generating electricity therein, wherein the syngas comprises H₂, CO and CO₂, and has a ratio of [H₂]/[CO] of about 1.4 to about 2.0; removing CO₂ from the syngas to produce a decarbonated syngas with a ratio of [CO₂]/[CO+CO₂] of no higher than 0.6 by directing the syngas through a carbon capture device comprising a metal oxide stabilized CaO sorbent at a temperature of about 600° C. to about 800° C.; removing water from the decarbonated syngas to produce a dehydrated syngas; and performing a Fischer-Tropsch synthesis on the dehydrated syngas under effective Fischer-Tropsch conditions in the presence of a cobalt-based

Fischer-Tropsch catalyst, said catalyst comprising pellets of trilobe, cylindrical, hollow cylinder or spherical construction with diameter about 0.5 mm to about 3.0 mm and aspect ratio of 1 to 3.5, to produce the hydrocarbonaceous compounds, steam and tail gas; and heating and oxidizing at least a portion of the tail gas to produce auxiliary heat for one or both of the removing CO₂ step and regenerating the metal oxide stabilized CaO sorbent in a regenerating carbon capture device.

In certain embodiments, the metal oxide is an Al oxide or a Zr oxide.

In certain embodiments, the internal reforming fuel cell is a molten carbonate fuel cell or a solid oxide fuel cell.

In certain embodiments, the hydrocarbonaceous compounds comprise liquid fuel and wax.

In certain embodiments: the wax is separated from other gaseous products of the Fischer-Tropsch synthesis in a hot trap; remaining gas is cooled in a cold trap to condense water and liquid fuel; and the liquid fuel is separated from said water.

In certain embodiments, impurities in the fuel stream entering the internal reforming fuel cell are reduced by a combination of sulfur capture, condensing, siloxane polishing and condensate treatment. Sulfur, ammonia and chlorine present in the fuel stream entering the internal reforming fuel cell may each be at less than 30 ppb.

In certain embodiments, the method further comprises causing a partial vacuum in a regenerating carbon capture device using at least a portion of steam produced from the Fischer-Tropsch synthesis or using at least a portion of high pressure tail gas in an ejector.

In certain embodiments, the removing water step comprises condensing out said water by cooling the decarbonated syngas.

In certain embodiments, the heating and oxidizing of the at least a portion of the tailgas comprises using heat generated from the cooling of the decarbonated syngas.

In certain embodiments, the method further comprises heating the dehydrated syngas for the Fischer-Tropsch synthesis using heat generated from the cooling of the decarbonated syngas or exothermic reaction heat generated from the Fischer-Tropsch synthesis.

In certain embodiments, the method further comprises compressing the dehydrated syngas prior to the Fischer-Tropsch synthesis.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a schematic diagram of a first non-limiting example of a method for producing hydrocarbon compounds in accordance with an embodiment of the present invention.

FIG. 2 shows a schematic diagram of a second non-limiting example of a method for producing hydrocarbon compounds in accordance with an embodiment of the present invention.

FIG. 3 shows a schematic diagram of a third non-limiting example of a method for producing hydrocarbon compounds in accordance with an embodiment of the present invention.

### DETAILED DESCRIPTION

The following description is of a preferred embodiment.

As used herein, the terms “comprising,” “having”, “including” and “containing,” and grammatical variations thereof, are inclusive or open-ended and do not exclude additional, unrecited elements and/or method steps. The term “consisting essentially of” if/when used herein in connection with a composition, use or method, denotes that additional elements and/or method steps may be present, but that these additions do not materially affect the manner in which the recited composition, method or use functions. The term “consisting of” if/when used herein in connection with a composition, use or method, excludes the presence of additional elements and/or method steps. A composition, use or method described herein as comprising certain elements and/or steps may also, in certain embodiments consist essentially of those elements and/or steps, and in other embodiments consist of those elements and/or steps, whether or not these embodiments are specifically referred to. A use or method described herein as comprising certain elements and/or steps may also, in certain embodiments consist essentially of those elements and/or steps, and in other embodiments consist of those elements and/or steps, whether or not these embodiments are specifically referred to.

A reference to an element by the indefinite article “a” does not exclude the possibility that more than one of the elements is present, unless the context clearly requires that there be one and only one of the elements. The singular forms “a”, “an”, and “the” include plural referents unless the content clearly dictates otherwise. The use of the word “a” or “an” when used herein in conjunction with the term “comprising” may mean “one,” but it is also consistent with the meaning of “one or more,” “at least one” and “one or more than one.”

Unless otherwise specified, “certain embodiments”, “various embodiments”, “an embodiment” and similar terms includes the particular feature(s) described for that embodiment either alone or in combination with any other embodiment or embodiments described herein, whether or not the other embodiments are directly or indirectly referenced and regardless of whether the feature or embodiment is described in the context of a method, use, system, et cetera.

Unless indicated to be further limited, the term “plurality” if/when used herein means more than one, for example, two or more, three or more, four or more, and the like.

As used herein, the term “about” refers to an approximately +/−10% variation from a given value. It is to be understood that such a variation is always included in any given value provided herein, whether or not it is specifically referred to.

As used herein, the recitation of numerical ranges by endpoints includes all numbers subsumed within that range including all whole numbers, all integers and all fractional intermediates (e.g., 1 to 5 includes 1, 1.5, 2, 2.75, 3, 3.80, 4, and 5 etc.).

As used herein, letters in parentheses used to organize method steps (e.g. “(a)”, “(b)”, “(bi)”, “(bii)”, “(c)”, “(d)”, “(e)”, and the like) are provided merely for reference and should not necessarily be understood as indicating a particular order or sequence of method steps, unless said order or sequence is otherwise explicitly or implicitly indicated.

The present disclosure relates to methods for producing hydrocarbon compounds.

In certain embodiments, there is provided a method for producing hydrocarbon compounds, the method comprising performing a Fischer-Tropsch synthesis with a fuel stream derived from syngas. In some embodiments, the method produces a fuel and a petrochemical rich product stream.

As used herein, a “hydrocarbon compound” means a molecule of any length which comprises a hydrocarbon, i.e. hydrogen and carbon atoms. For example, a hydrocarbon compound may be a liquid fuel, wax or the like. A hydrocarbon compound may have any number of carbons from 1, 2, 3, 4, 5, 6, 7, 8, 9, 10, 11, 12, 13, 14, 15, 16, 17, 18, 19, 20, 21, 22, 23, 24, 25, 26, 27, 38, 29, 30, 32, 34, 46, 38, 40, or more than 40 carbons. A hydrocarbon compound may be linear, branched, olefinic, paraffinic, cyclic or a mixture thereof. Hydrocarbon compounds includes one or a plurality of different types of compounds.

As used herein, “syngas” or “synthesis gas” is a fuel gas mixture comprised primarily of hydrogen gas (H₂), carbon monoxide (CO) and carbon dioxide (CO₂), and may also comprise one or more of water, nitrogen gas (N₂), impurities (e.g. sulfur, siloxanes, chlorine, oxygen, ammonia, sulfur, volatile organic compounds and the like) as well as small hydrocarbons (e.g. C₁-C₄ and the like), oxygenates (e.g. alcohols, ethers and the like) and other gases. The syngas may be derived from any hydrocarbon-containing source: e.g. solid or semi-solid raw material (e.g. biomass, coal or the like) which can be gasified; any gas which comprises gaseous hydrocarbons which can be reformed (e.g. via steam reforming, autothermal reforming, cold plasma reforming, dry reforming or internal-reforming fuel cells); or a mixture H₂ and CO generated from any other source, such as syngas and/or syngas products derived from microbial processes, advanced biofuels and chemicals production, or a combination thereof.

In certain embodiments, the method further comprises producing the syngas by introducing a fuel stream comprising a reformable fuel into a reforming system.

Reformable fuels may comprise any short chain hydrocarbons or alcohols. The reformable fuel stream may be derived from a biogas, a landfill gas, natural gas, or a gas from gasification of biomass or coal, or any other gas comprising gaseous hydrocarbons or a mixture of H₂ and CO. As used herein, “biogas” refers to a mixture of different gases produced by the breakdown of organic matter in the absence of oxygen. Biogas may be produced from raw materials such as agricultural waste, manure, municipal waste, plant material, sewage, green waste, food waste, algae, bacteria or the like. For example, but without limitation, the biogas may be from a landfill, digester or anaerobic digestion (AD) plant or from syngas production based upon microbial (e.g. bacterial activity) alone or in combination with advanced biofuels and chemicals production.

In certain embodiments, sulfur, ammonia and chlorine present in the fuel stream entering the reforming system are each at less than 30 ppb. In certain embodiments, the method further comprises reducing impurities (including, e.g., siloxanes, oxygen, sulfur, ammonia, chlorine, volatile organic compounds and the like) and/or water in the fuel stream prior to entering the reforming system using a scrubber, a filter, an electrostatic device, a baghouse, cyclone scrubber or a combination thereof. A non-limiting example of a method of reducing impurities in the fuel stream is disclosed in Canadian Patent Application No. 2709722 (commercially available from Quadrogen Power Systems, Inc.) and includes condensation, conversion, capture and/or polishing steps. In one example, the biogas feed is cooled to condense water and other contaminants such as siloxanes and volatile organic compounds. Condensed liquids are then separated from the gas stream to remove a large proportion of the contaminants without using any adsorbent media. Dry feed gas is treated with a hydrogen-assisted catalytic process that converts organic contaminants into a known set of species. Sorbent media beds, specifically tailored to the known species produced by the conversion stage, are then used to capture the remaining contaminants. Lastly, the biogas is further polished of contaminants to the parts-per-billion level in a chemisorption-based gas clean up step. In another example, landfill gas is treated with sulfur capture, condensing, siloxane polishing and condensate treatment. Many other such biogas purification methods and systems are known.

For example, the reforming system may comprise one or more of a steam reformer, an autothermal reformer, a cold plasma reformer or a fuel cell (e.g. an internal reforming fuel cell, such as a molten carbonate fuel cell (MCFC), a solid oxide fuel cell (SOFC) and the like). The reforming system may comprise an internal reforming fuel cell alone. The reforming system may comprise a steam reformer, autothermal reformer or plasma reformer, alone or combined with a fuel cell. The syngas generated by the steam reformer, autothermal reformer or plasma reformer may or may not be directed into an internal-reforming fuel cell (e.g. MCFC or SOFC) to generate electricity while leaving the unreacted syngas available for Fischer-Tropsch synthesis in a downstream process step.

Steam reforming converts steam and reformable fuel into syngas and CO₂ while requiring temperatures ranging from 600 to 900° C. and pressures ranging from atmospheric pressures to 30 bar. The reaction is highly endothermic. Such a process generally generates a hydrogen rich syngas with possible H₂:CO ratios ranging between 4 to 7. Variation of operating conditions exploiting the water gas shift equilibrium can lead to even higher H₂:CO ratios.

Autothermal reforming involves coupling the endothermic steam reforming reaction with the exothermic partial oxidation of the reformable fuels. The process is adiabatic and can be manipulated to generate syngas with H₂:CO ratios close to 2. The exit temperatures for syngas from reactors can be more than 1000° C.

A cold plasma reformer can carry out the autothermal reforming reactions without the use of a catalyst, thereby overcoming many limitations imposed on the process with regards to the feed gas stream purity. The process utilizes a sliding plasma arc to generate radicals and ions. The operating temperatures are governed by the thermodynamic limitations.

In certain embodiments where the reforming system comprises a fuel cell, the fuel cell may be an internal reforming fuel cell. In some embodiments, the internal reforming fuel cell is a MCFC. In some embodiments, the internal reforming fuel cell is a SOFC. Both MCFC and SOFC are known and commercially available. A non-limiting example of a MCFC is disclosed in US Patent Publication No. 5897972. A non-limiting example of a SOFC is disclosed in European Patent Publication No. EP0442743. In general terms, either a MCFC or an SOFC comprises an electrolyte sandwiched between a cathode and an anode.

For the operation of a SOFC, oxygen reacts with electrons at the cathode to form oxygen ions, which are conducted through the ion-conducting electrolyte to the anode according reaction (7). At the anode, oxygen ions combine with hydrogen and carbon monoxide to form carbon dioxide and water thereby liberating electrons according to exothermic reactions (8) and (9). Fuel cells are stacked and interleaved with interconnect plates which distribute gases to the electrode/electrolyte interfaces and which also act as current collectors.

½O₂+2e→O²⁻ (7)

H₂+O²⁻→H₂O+2e (8)

CO+O²⁻→CO₂+2e (9)

MCFC operate with the use of carbonate ions as an electron carrier from the cathode to anode through a molten carbonate electrolyte. The cathode inlet gas contains a mixture of CO₂ and O₂, while the anode inlet gas contains H₂. The CO₂ and O₂ react at the cathode to form carbonate ions, which is transferred to the anode, where the carbonate ion oxidizes the H₂ to release the electrons while generating H₂O and CO₂ as byproducts. The oxidation of H₂ is highly exothermic, thereby allowing the coupling of a secondary endothermic reaction in situ, such as steam reforming (or another reforming system). Typically, steam reforming results in high H₂:CO ratios, which make it unsuitable for direct application to most chemical synthesis processes, such as methanol synthesis or Fischer-Tropsch synthesis. However, if coupled with an MCFC, part of the excess H₂ can be consumed for operation of the cell, thereby making the H₂:CO ratio of the remaining syngas more suitable for direct application to further chemical processes downstream. The overall process would then utilize a mixture of reformable fuels and steam as feed for the anode inlet and a mixture of CO₂ and O₂ as feed for the cathode inlet, essentially making the device a methane fuel cell.

A MCFC uses a molten carbonate electrolyte generally maintained close to 650° C. in an electrolytic plate. Carbonate ion (CO₃²⁻) is generated by the reaction of CO₂ and O₂ at the cathode (reaction 10). The carbonate ion is transmitted to the anode through the electrolyte and reacts with H₂ at the anode to produce CO₂ and H₂O while releasing electrons to the anode (reaction 11).

Cathode reaction:

CO₂+½O₂e⁻→CO₃²⁻ (10)

Anode reaction

CO₃²⁻+H₂→H₂O+CO₂+2e⁻ (11)

In addition to generating electricity, the oxidation of H₂ at the anode also liberates significant amount of energy, thereby allowing the coupling a high temperature endothermic reaction in the system. The MCFC is therefore capable of generating H₂ in situ in the form of syngas (CO+H₂), via the steam reforming reactions (2) to (4). This reaction converts small hydrocarbons or alcohols along with steam to syngas and CO₂. The H₂ in the syngas is then consumed electrochemically in a reaction with the fuel cell electrolyte ions to produce water and electrons as in reactions (10) and (11). The water requirement for the steam methane reforming reaction may be substantially nullified by recycling the H₂O generated by virtue of the anode reaction (11).

In the case of using an internal reforming MCFC, a portion of the hydrogen is used for generating electrical power, while releasing unreacted H₂ along with CO, CO₂ and H₂O as the anode exhaust. The anode exhaust can undergo moisture removal as well as CO₂ removal steps to generate syngas of suitable quality for carrying out the Fischer-Tropsch synthesis reaction. At least part of the electricity generated at the fuel cell may be utilized to operate the auxiliary units involved in the Fischer-Tropsch method/system.

In some embodiments, the fuel cell anode exhaust syngas comprises H₂, CO and CO₂, and has a ratio of [H₂]/[CO] of about 1.4 to about 2.5, e.g. the ratio may be 1.38, 1.4, 1.5, 1.6, 1.7, 1.8, 1.9, 2.0, 2.1, 2.2, 2.3, 2.4, 2.5 and any decimal value in between or any range contained therein. In certain embodiments, the [H₂]/[CO] ratio is from about 1.6 to about 2.2, from about 1.4 to about 2.0, from about 1.6 to about 2.0 or from about 1.4 to about 2.2. The ratio of [H₂]/[CO] may be controlled by manipulating the fuel feeding rate in the fuel cell, CO₂ return rate to the cathode side and electricity generation. The combination of steam reformer, autothermal reformer or plasma reformer along with MCFC or SOFC may generate syngas with the aforementioned H₂:CO ratios, which would make the gas a suitable feed for the Fischer-Tropsch synthesis reaction. This would allow the electricity generated by the fuel cell to be used for powering auxiliary systems involved in the overall process loop. Alternatively, the synthesis gas generation techniques, including the fuel cell (utilized as an internal reforming cell) may be used as standalone processes for providing feed for the Fischer-Tropsch reaction system.

Steam for reforming reactions (2) to (4) is produced on the anode side of the fuel cell by oxidizing H₂ (reaction (8) or reaction (11)). In some embodiments, additional steam for reactions (2) to (4) may be recycled from the aqueous product of Fischer-Tropsch reaction.

In some embodiments, while utilizing steam reforming, autothermal reforming, or cold plasma reforming, additional steam for reactions (2) to (4) may be recycled from the aqueous products of the Fischer-Tropsch reaction.

The water-rich product fraction from the cobalt or iron catalyst based Fischer-Tropsch synthesis reaction contains alcohols, primarily methanol in the range of 0.5 -2%. The alcohols may be utilized as a reformable fuel along with methane. This would significantly decrease the water footprint of the overall process, as well as decrease processing required for water downstream of the Fischer-Tropsch reactor. The methanol reforming reaction (12) generates additional H₂ for the system.

CH₃OH+H₂O→CO₂+3H₂O (12)

The syngas from the fuel cell exhaust may comprise large quantities of CO₂, which increases the CO₂/(CO₂+CO) ratio and thus favours the production of methane over larger more desirable products in the Fischer-Tropsch reactor. For example, biogas often contains 30-50% CO₂ and when biogas is consumed in a fuel cell (e.g. a MCFC or SOFC), it will produce more CO₂, resulting in a CO₂ content in fuel cell anode exhaust that is often above 40%. It is therefore desirable as an option to remove CO₂ (or even the majority of CO₂) from the syngas mixture before feeding to the Fischer-Tropsch reaction system. Accordingly, in certain embodiments, the method further comprises removing CO₂ from the syngas (or dehydrated syngas) to produce a decarbonated syngas (or a decarbonated and dehydrated syngas) with a ratio of [CO₂]/[CO+CO₂] of no higher than 0.40, 0.45, 0.50, 0.55, 0.60, or any decimal value in therebetween, by directing the syngas through a through a CO₂ capture or separation device. This CO₂ separation system may comprise a solvent-based absorption process (such as Rectisol™, Selexol™, and other such acid gas removal processes), pressure swing adsorption (PSA) or a chemical sorbent at high temperature. The removed CO₂ may also result in the production of clean or uncontaminated CO₂, which may be recycled, sold or used on other processes.

In some embodiments of the method which use chemical sorbents for CO₂ removal, the chemical sorbent is a metal oxide stabilized CaO sorbent or an alkaline-based sorbent. For example, the metal oxide may be an Al oxide, A Mg oxide or a Zr oxide. For example, but without limitation, the sorbent may be Li₂ZrO₃, Na₂ZrO₃ or Li₄SiO₄. In some embodiments, the temperature of the carbon capture is of about 600° C. to about 800° C. Carbon capture devices comprising chemical sorbents, such as metal oxide stabilized CaO sorbents, are known. Some non-limiting examples are disclosed in the PhD thesis of Hamid Reza Radfarnia (“High-Temperature CO₂ Sorbents and Application in the Sorption Enhanced Steam Reforming for Hydrogen Production”, 2013, Laval University, Québec, Canada). For example, a metal stabilizer can be incorporated into CaO by wet-mixing the metal stabilizer with washed limestone, dried, and then calcined. For example, the limestone may be prewashed to reduce NaCl content. The limestone may be further washed in citric acid or another acid (e.g. 1.035 gr limestone treated with 1.42 g citric acid for about 15 minutes at 70-75° C. in about 75 mL). The metal stabilizer may then be added (e.g. in a solution of about 100 mL), vigorously stirred and then dried overnight at 70-75° C. to form a dried cake. Ground cake may then be calcined in a furnace, ramped initially from ambient to 900° C. (10° C./min) in argon flow and then switched to air atmosphere for 21 hours (for example). An example of particle size for the metal stabilized CaO is 75 to 600 μm. This carbon capture device itself may be in the form of one or more than one column comprising the sorbent.

In some embodiments of the method which use chemical sorbents for CO₂ removal, the method further comprises regenerating the sorbent. Metal oxide CaO sorbents produce CaCO₃, as in reaction (13) below. The other syngas components (e.g. H₂O, CO, N₂ and H₂) pass through the CO₂ capture device. It has been measured that each kilogram of calcium oxide is capable of capturing up to about 0.786 kg of CO₂. Sorption rates increase with higher pressure and temperature. Since reaction (13) is reversible, at lower pressure and higher temperature calcium carbonate decomposes to calcium oxide and carbon dioxide (i.e. regenerating the sorbent). The regeneration rate is four times slower than the sorption rate; thus, in some embodiments, for each column in the CO₂ capturing process, a plurality of columns (e.g. 4 or 5 columns) are undergoing the regeneration process. In some embodiments, the method further comprises causing a partial vacuum in a regenerating carbon capture device using at least a portion of steam produced from Fischer-Tropsch synthesis (e.g. in a steam ejector) or a portion of high pressure tail gas (e.g. in a gas ejector). In some embodiments, the method further comprises oxidizing tail gas from Fischer-Tropsch synthesis to provide the required heat for regeneration. Removed CO₂ may be sold separately, used in another process, or recycled into the method, e.g. returned to the cathode side of the fuel cell (e.g. MCFC). The decarbonated syngas stream may have a temperature approximately in the 550° C. to 600° C. range, for example.

CaO+CO₂ [symbol] CaCO₃ (13)

In some embodiments, the method further comprises Sorption Enhanced Steam Reforming (SESR), which integrates both CO₂ capture and H₂ production in a single process. This process may be used to adjust the H₂/CO ratio in high CO₂, high temperature applications where the ratio is too low for effective Fischer-Tropsch fuel production from syngas. SESR is described in the PhD thesis of Hamid Reza Radfarnia (“High-Temperature CO₂ Sorbents and Application in the Sorption Enhanced Steam Reforming for Hydrogen Production”, 2013, Laval University, Québec, Canada).

In some embodiments, the method comprises removing water from the syngas (or decarbonated) syngas to produce a dehydrated syngas (or a decarbonated and dehydrated syngas). Without limitation, the water removal step may comprise, for example, condensing out said water by cooling the syngas (or decarbonated syngas). The temperature and other conditions for cooling may be any which condense water from the gas. For example, a heat exchanger may be used to drop the temperature to about 50, about 45, about 40, about 35, about 30, about 25, about 20, about 15, about 10° C., or any temperature in between. In some embodiments, the water is condensed at about 35° C. In some embodiments, the water is condensed at about 15° C. The pressure during the condensation step may be the pressure at which the corresponding temperature is below the dew point of water.

In certain embodiments, syngas from the reforming system may be cooled to remove the water and produce a dehydrated syngas. The temperature and other conditions for cooling may be any which condense water from the gas. For example, a heat exchanger may be used to drop the temperature to 50, 45, 40, 35, 30, 25, 20, 15, 10° C., or any temperature in between. In some embodiments, the water is condensed at about 35° C. In some embodiments, the water is condensed at about 15° C. The pressure during the condensation step may be the pressure at which the corresponding temperature is below the dew point of water. The CO₂ content from the dehydrated syngas may then be removed as described herein (e.g. the solvent-based absorption process PSA process or high temperature chemical sorbent process).

In some embodiments, the method further comprises compressing the dehydrated syngas mixture prior to the Fischer-Tropsch synthesis. For example, the dehydrated syngas mixture may be pressurized to a pressure of about 15 to about 40 barg, any value or range in between, or any other pressure suitable for Fischer-Tropsch synthesis.

In some embodiments, the method further comprises heating the dehydrated and pressurized syngas prior to the Fischer-Tropsch synthesis. The heat for this step may be recycled from the heat generated from the cooling of the decarbonated syngas. The heat may be recovered from exothermic heat of the Fischer-Tropsch synthesis. In certain embodiments, the syngas is heated to about 180° C. to about 230° C. In certain embodiments, the syngas is heated to about 200° C. to about 220° C. (e.g. to 200, 201, 202, 203, 204, 205, 206, 207, 208, 209, 210, 211, 212, 213, 214, 215, 216, 217, 218, 219 or 220° C.), depending on the activity of the particular Fischer-Tropsch catalyst.

The method further comprises performing a Fischer-Tropsch synthesis on the syngas (e.g. dehydrated syngas) under effective Fischer-Tropsch conditions in the presence of a cobalt- or iron-based Fischer-Tropsch catalyst to produce a product stream comprising hydrocarbon compounds. The Fischer-Tropsch catalyst comprises pellets of trilobe, cylindrical, hollow cylinder or spherical construction with diameter about 0.5 mm to about 3.0 mm and aspect ratio of 1 to 3.5. The Fischer-Tropsch catalyst may comprise pellets of trilobe construction with a diameter of about 0.8 mm to about 1.8 mm and an aspect ratio of 2 to 3.5. In some embodiments, the Fischer-Tropsch catalyst is a cobalt-based catalyst. In some embodiments, the Fischer-Tropsch catalyst is a iron-based catalyst. Effective Fischer-Tropsch conditions are known. Since the Fischer-Tropsch synthesizing reaction is extremely exothermic, excess heat may be removed from the catalytic chamber by saturated high pressure water on the shell side to keep the whole process as isothermal as possible, or by using thermal heat transfer fluids (e.g. Dowtherm™, Therminol™ and the like). Saturated water may then be converted to steam in a separate drum, e.g. for recycling.

If the H₂/CO ratio is less than 2, there will be excess CO in the tail gas and almost all H₂ will be consumed in the process. In such a case, product distribution will be toward heavier liquid products and wax. The size/range of products depends on inlet pressure, temperature, gas composition, the H₂/CO ratio and the effectiveness of the heat removal system. The small grain cobalt catalyst disclosed herein is effective for sub-stoichiometric operation of Fischer-Tropsch synthesis under the conditions disclosed herein, depending on activity of the catalyst. Alternatively, if an iron based catalyst is utilized, the water gas shift reaction may be utilized to alter the H₂:CO ratio to close to 2.

The hydrocarbon compounds produced by the Fischer-Tropsch reaction may comprise liquid fuel, petrochemicals and wax. In some embodiments, the method further comprises separating the wax from other gaseous products of the Fischer-Tropsch synthesis (e.g. but without limitation, in a hot trap). Hot trap configurations and conditions are known. In some embodiments, the method further comprises cooling the other gaseous products from the hot trap (e.g. to about 35, 34, 33, 32, 31, 30, 29, 28, 27, 26, 25, 24, 23, 22, 21, 20, 19, 18, 17, 16, 15, 14, 13, 12, 11, 12, 10, 9, 8, 7, 6 or 5° C.), e.g. but without limitation in a cold trap, to condense water and liquid fuel (i.e. aqueous products). Cold trap configurations and conditions are known. In some embodiments, the method further comprises separating the liquid hydrocarbons from said water fraction (e.g. by known gravity methods). In some embodiments, the method further comprises recycling at least a portion of the aqueous products into the reforming system, e.g. to generate additional hydrogen in the syngas produced from the reforming system. Based on the particular context, “tail gas” as used herein may refer to gaseous products derived from Fischer-Tropsch synthesis following a separation step, e.g. after a cold trap.

In some embodiments, the method further comprises using at least a portion of the tail gas from the Fischer-Tropsch synthesis to produce one or more of liquid or solid CO₂, cooled tail gas as a feed for the Fischer-Tropsch synthesis, and auxiliary heat for removing CO₂ in the CO₂ removal step.

In certain embodiments, the method further comprises regenerating the metal oxide stabilized CaO sorbent by causing a partial vacuum in the carbon capture device using at least a portion of the steam or high pressure tail gas produced from the Fischer-Tropsch synthesis. Captured CO₂ may be regenerated from the CaO based carbon capture device by a combined vacuum-temperature swing. The required heat and steam or pressurized tail gas for regeneration may be supplied from the exothermic Fischer-Tropsch reaction in the reactor and by oxidizing the remaining CO, H₂ and CH₄ in the tail gas downstream of the Fischer-Tropsch reaction. Accordingly, in some embodiments, the method further comprises heating and oxidizing at least a portion of the tail gas to produce auxiliary heat for one or both of the CO₂ removal step as well as the regeneration of the metal oxide stabilized CaO sorbent in a regenerating carbon capture device. In certain embodiments, the step of heating and oxidizing of the at least a portion the tail gas comprises using heat recovered from the cooling of the decarbonated syngas. Oxidation of the tail gas may take place in a catalytic chamber with an oxygen source (e.g. air and the like).

In certain embodiments, the method further comprises depressurizing part of the tail gas adiabatically (e.g. through a nozzle) to cool the gas mixture and separate out part of the CO₂ as liquid CO₂ and/or dry ice.

In certain embodiments, the cooled tail gas can be utilized to cool the dehydrated and decarbonated syngas prior to feeding to the compressor en route to the Fischer-Tropsch reactor.

In certain embodiments, part of the cooled tail gas may be utilized as a refrigerant to maintain the cool temperature of the cold trap, and/or to regulate the temperature of the Fischer-Tropsch reactor system.

In certain embodiments, part of the tail gas is recycled and mixed with the dehydrated syngas en route to the Fischer-Tropsch reactor.

In some embodiments, the method comprises utilizing part of the recovered clean CO₂ stream for generating biological butanol and/or pentanol, e.g. via the photosynthetic action of designer cyanobacteria, photosynthetic bacteria, or other bacteria.

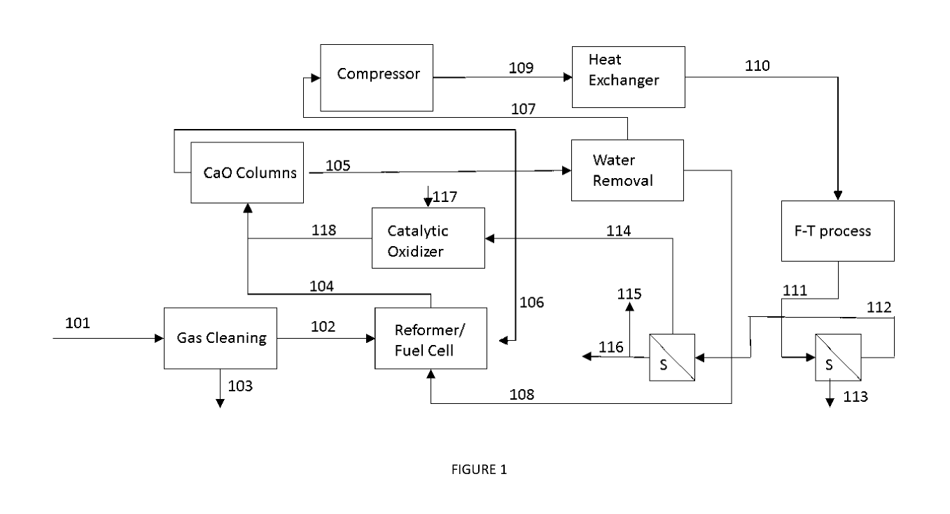

This disclosure also provides a system for producing hydrocarbon compounds. The system may comprise any one or more of the elements shown in FIGS. 1 to 3 and/or as disclosed in the method herein.

The present invention will be further illustrated in the following examples.

### EXAMPLE 1

### Integrating 1.4 MW Fuel Cell with Sub-Stoichiometric Cobalt Catalyst Based Fischer-Tropsch, Consuming Landfill Gas Using CaO Based CO₂ Capture Technology

A schematic diagram for an exemplary method for producing hydrocarbon compounds is shown in FIG. 1.

A fuel stream 101 of landfill gas comprising about 50% CO₂ and 50% methane was cleaned to produce a cleaned fuel stream 102 by removing impurities 103. Fuel stream 101 was cleaned as described in Canadian Patent Application 2,709,722 and included four steps to process the landfill gas to meets the specification requirements of the fuel cell: sulfur capture, condensing, siloxane polishing and condensate treatment.

The cleaned fuel stream 102 was fed into a 1.4 MW MCFC (DRC1500, FuelCell Energy, Inc.) to generate electricity and produce syngas 104. The heating value of the landfill gas was 17.74 MJ/m³. Electrical efficiency in the 1.4 MW MCFC was 47%. Fuel consumption of the 1.4 MW fuel cell was 601.77 sm³/hr. Dry and clean biogas 102 was fed into the anode of the 1.4 MW MCFC where the methane was reformed to CO and H₂ and most of the H₂ reacted with the carbonate electrolyte (CO₃²⁻) to generate electrical power and heat. The properties of the anode exhaust (i.e. syngas 104) are summarized in Table 1, below.

TABLE 1
Properties of Stream 104 (FIG. 1)

| | Mole fraction % | kg/hr |
|---|---|---|
| CARBON | 6.2% | 255.18 |
| MONOXIDE | | |
| CARBON DIOXIDE | 44.20% | 2872.61 |
| HYDROGEN | 9.90% | 29.25 |
| WATER | 37.50% | 997.02 |
| NITROGEN | 2.20% | 90.99 |
| Mass flow rate | 4245.75 | |
| Pressure | 0.3 | barg |
| Temperature | 600° | C. |

The syngas 104 was fed into a carbon capture device based on CaO adsorption columns, to produce decarbonated syngas 105 and captured CO₂ 106, which may be recycled for sale or as feed for the MCFC. The ratio of CO₂/(CO₂+CO) was more than 0.5, thus 86% of CO₂ (2872.6*0.86=2470 kg/hr) was targeted to be removed. It was estimated that 0.6 kg CO₂ could be absorbed by one kilogram of CaO, that it would take approximately 30 min of absorption time for each column, and that 2060 kg of CaO would be required for each column. Four columns were regenerated per column used in the decarbonation step.

At this stage, the decarbonated syngas 105 had a temperature of about 550° C. to about 600° C. and too high of water content for Fischer-Tropsch synthesis. The decarbonated syngas 105 was therefore cooled to 35° C. to condense out all water content, producing dehydrated syngas 107 and condensed water 108. Condensed water 108 may be recycled back into the fuel cell. A lower temperature was also required for the compressor inlet in the next step of the method. The properties of streams 105 and 107 are summarized in Table 2, below.

TABLE 2
Properties of Streams 105 and 107 (FIG. 1)

| | Stream 105 | | Stream 107 | |
|---|---|---|---|---|
| | Mole | | Mole | |
| | fraction % | kg/hr | fraction % | kg/hr |
| CARBON MONOXIDE | 9.96% | 255.18 | 25.23% | 255.18 |
| CARBON DIOXIDE | 9.99% | 402.16 | 25.29% | 402.16 |
| HYDROGEN | 16.04% | 29.24 | 40.62% | 29.24 |
| WATER | 60.51% | 997.02 | 0.00% | 0 |
| NITROGEN | 3.50% | 90.98 | 8.86% | 90.98 |

| Mass flow rate | 1774.6 | | 777.6 |
|---|---|---|---|
| Pressure | 0.2 | barg | 0.1 |
| Temperature | 600° | C. | 35° C. |

The dehydrated syngas 107 was then pressurized to 15 barg using an oil free compressor. Compressor outlet temperature was in the range of approximately 160 to 180° C. The resulting pressurized syngas 109 was further heated to approximately 200 to 220° C. (stream 110) by a shell and tube heat exchanger using the heat generated from the production of stream 107 (i.e. from condensation of water from stream 105).

The resultant pressurized and heated syngas 110 was then fed into the Fischer-Tropsch reactor. The Fischer-Tropsch reaction took place in a vertical, fixed bed, multi tubular reactor. Reactor construction was similar to a shell and tube heat exchanger. The tube side was filled with packed cobalt-based catalyst. Catalyst pellets were of trilobe construction with a diameter 0.8 mm to 1.8 mm and an aspect ratio of 2 to 3.5. The Fischer-Tropsch reaction in the tubes was extremely exothermic; 280 KW of thermal energy was generated for conversion of 65% of inlet CO to hydrocarbons. The shell side was filled with Therminol™ fluid. The composition of stream 111 from the reactor outlet is shown in Table 3, below.

TABLE 3
Properties of Stream 111 (FIG. 1).

| | Mole fraction % | kg/hr |
|---|---|---|
| CARBON MONOXIDE | 12.6% | 84.3 |
| CARBON DIOXIDE | 38.2% | 403.5 |
| HYDROGEN | 7.8% | 3.7 |
| WATER | 25.0% | 107.7 |
| NITROGEN | 13.3% | 89.6 |
| Methane | 1.1% | 4.4 |
| Light hydrocarbons | 0.8% | 37.9 |
| Heavy hydrocarbons | 0.9% | 33.7 |
| Oxygenates | 0.3% | 12.6 |

| | | |
|---|---|---|
| Total Mass flow rate | 777.6 | kg/hr |
| Liquid flow rate per day | 988.77 | kg |
| Wax per day | 809 | kg |
| Pressure | 19.9 | barg |

| | |
|---|---|
| Temperature | 211.6 |

Wax 113 was separated from gas stream 111 using a hot trap at 220-180° C. The remaining gas stream 112 was cooled to 5-15° C. in a cold trap to condense all of the aqueous product as stream 116 and liquid hydrocarbons as stream 115. Liquid hydrocarbon product 115 (e.g. light hydrocarbons in Table 3) was separated from aqueous product 116 by known gravity methods.

Remaining tail gas 114 from the cold trap contained unreacted CO and H₂ together with small chain hydrocarbons (e.g. C1-C4), CO₂ and water. The tail gas 114 was heated to 300° C. using the heat from the water removal step and then oxidized with excess air (stream 117) to produce stream 118 at a temperature of 850° C. to provide auxiliary heat for the CO₂ removal step.

### EXAMPLE 2

### Integrating 1.4 MW Fuel Cell with Sub-Stoichiometric

Fischer-Tropsch, consuming landfill gas, recycling the aqueous product of the FT reaction back into the MCFC for the reforming reaction step, utilizing Selexol™ as the CO₂ capture technology.

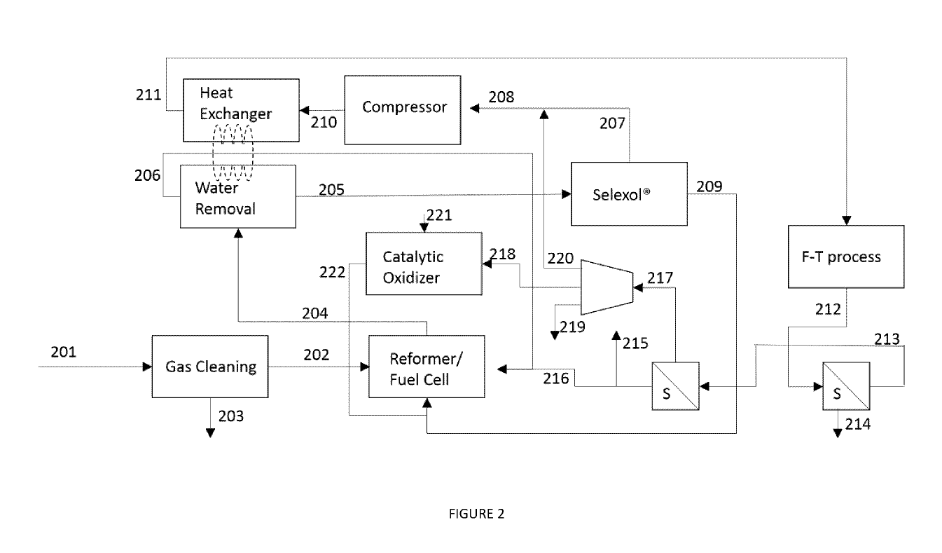

A schematic diagram for an exemplary method for producing hydrocarbon compounds is shown in FIG. 2.

A fuel stream 201 of landfill gas comprising about 50% CO₂ and 50% methane was cleaned to produce a cleaned fuel stream 202 by removing impurities 203. Fuel stream 201 was cleaned as described in Canadian Patent Application 2,709,722 and included four steps to process the landfill gas to meets the specification requirements of the fuel cell: sulfur capture, condensing, siloxane polishing and condensate treatment.

The cleaned fuel stream 202 as well as recycled aqueous stream 216 were fed into a 1.4 MW MCFC (DRC1500, FuelCell Energy, Inc.) to generate electricity and produce syngas 204. The heating value of the landfill gas was 17.74 MJ/m³. Electrical efficiency in the 1.4 MW MCFC was 47%. Fuel consumption of the 1.4 MW fuel cell was 601.77 sm³/hr. Dry and clean biogas 202 was fed into the anode of the 1.4 MW MCFC where the methane was reformed to CO and H₂ and most of the H₂ reacted with the carbonate ion (CO₃²⁻) to generate electrical power and heat. The properties of the anode exhaust (i.e. syngas 204) are summarized in Table 4, below. Aqueous product stream 216 from the Fischer-Tropsch reactor containing oxygenates (primarily methanol) was also fed into the MCFC cell.

TABLE 4
Properties of Stream 204 (FIG. 2)

| | Mole fraction % | kg/hr |
|---|---|---|
| CARBON MONOXIDE | 6.16% | 255.19 |
| CARBON DIOXIDE | 44.16% | 2873.8 |
| HYDROGEN | 10.06% | 29.76 |
| WATER | 37.42% | 996.12 |
| NITROGEN | 2.20% | 90.99 |

| Mass flow rate | 4245.84 | |
|---|---|---|
| Pressure | 0.3 | barg |
| Temperature | 600° | C. |

The syngas 204 was then cooled to 35° C. to condense out all the water content and generate syngas stream 205. The water stream 206 was available for recycling to the fuel cell anode inlet. The syngas 205 stream was then fed into the Selexol™ CO₂ removal system to produce decarbonated syngas 207 and captured CO₂ stream 209, which may be recycled for sale or as feed for the MCFC. The Selexol™ system is capable of removing 88% of CO₂ from the gas stream and allowing a recovery of 98.7% of CO and 99.6% of H₂.

The properties of streams 205 and 207 are summarized in Table 5, below.

TABLE 5
Properties of Streams 205 and 207 (FIG. 2)

| | Stream 205 | | Stream 207 | |
|---|---|---|---|---|
| | Mole | | Mole | |
| | fraction % | kg/hr | fraction % | kg/hr |
| CARBON MONOXIDE | 9.85% | 255.19 | 25.77% | 251.87 |
| CARBON DIOXIDE | 70.56% | 2873.80 | 22.46% | 344.86 |
| HYDROGEN | 16.08% | 29.76 | 42.46% | 29.64 |
| WATER | 0% | 0 | 0.00% | 0 |
| NITROGEN | 3.51% | 90.99 | 9.31% | 90.99 |

| | | |
|---|---|---|
| Mass flow rate | 3249.73 kg/hr | 717.35 |

The dehydrated syngas 207 was then mixed with recycled tail gas stream 220, to generate syngas mix stream 208.

Stream 208 was pressurized to 30 barg using an oil free compressor. Compressor outlet temperature was in the range of approximately 160 to 180° C. The resulting pressurized syngas 210 was further heated to approximately 200 to 220° C. (stream 211) by a shell and tube heat exchanger using the heat generated from the production of stream 205 (i.e. from condensation of water from stream 204).

The resultant pressurized and heated syngas 211 was then fed into the Fischer-Tropsch reactor. The Fischer-Tropsch reaction took place in a vertical, fixed bed, multi tubular reactor. Reactor construction was similar to a shell and tube heat exchanger. The tube side was filled with packed cobalt-based catalyst. Catalyst pellets were of trilobe construction with a diameter 0.8 mm to 1.8 mm and an aspect ratio of 2 to 3.5. The Fischer-Tropsch reaction in the tubes was extremely exothermic; 280 KW of thermal energy was generated for conversion of 65% of inlet CO to hydrocarbons. The shell side was filled with Therminol® fluid. The composition of stream 211 as well as stream 212 leaving the reactor outlet are shown in Table 6, below.

TABLE 6
Properties of Streams 211 and 212 (FIG. 2)

| | Stream 211 | | Stream 212 | |
|---|---|---|---|---|
| | Mole | | Mole | |
| | fraction % | kg/hr | fraction % | kg/hr |
| CARBON MONOXIDE | 23.56% | 292.88 | 10.77% | 102.51 |
| CARBON DIOXIDE | 29.42% | 574.76 | 38.43% | 574.76 |
| HYDROGEN | 34.48% | 30.62 | 3.61% | 2.45 |
| WATER | 0% | 0 | 29.20% | 120.64 |
| NITROGEN | 12.20% | 151.65 | 15.93% | 151.65 |
| Methane | 3.06% | 2.18 | 1% | 5.44 |
| Light hydrocarbons | 0.03% | 0.67 | 0.11% | 1.66 |
| Heavy hydrocarbons | 0% | 0 | 0.76% | 91.10 |
| Oxygenates | 0% | 0 | 0.2% | 2.18 |

| | | |
|---|---|---|
| Total Mass flow rate | 1052.74 kg/hr | 1052.38 kg/hr |
| Liquid flow rate per day | | 1202.48 |
| Wax per day | | 983.85 |
| Pressure (bar) | 30 | 29.89 |
| Temperature (° C.) | 204 | 212 |

Wax 214 was separated from gas stream 212 using a hot trap maintained at 220 to 180° C. The remaining gas 213 was cooled to 5-15° C. in a cold trap to condense all of the aqueous product as stream 216 and liquid hydrocarbons as stream 215. Liquid hydrocarbon product 215 was separated from the aqueous components 216 by known gravity methods.

The aqueous stream 216 contains oxygenates (primarily methanol) and H₂O which are both recycled back into the MCFC for the reforming reaction. This would yield the twin benefits of decreasing the water footprint of the process, as well to decrease the water treatment required downstream of the Fischer-Tropsch process.

Remaining tail gas 217 from a cold trap contained unprocessed CO and H₂ together with small chain hydrocarbons (e.g. C1-C4), CO₂ and water. The tail gas 217 was depressurized adiabatically through a nozzle to separate out part of the CO₂ as dry ice (219) from the remaining tail gas. The tail gas was split into streams 220 and 218 in the ratio of 40:60 respectively. Stream 218 was heated using the heat from the water removal step and then oxidized with excess air (stream 221) to produce stream 222 at a temperature of 850° C. to provide auxiliary heat. The CO₂ rich stream 222 may be utilized in the cathode gas stream for reformation.

### EXAMPLE 3

### Integrating Cold Plasma Reformer with Sub-Stoichiometric Fischer-Tropsch, Consuming Landfill Gas, Recycling the Aqueous Product of the FT Reaction Back into the Reformer for the Reforming Reaction Step, Utilizing Selexol™ as the CO₂ Capture Technology

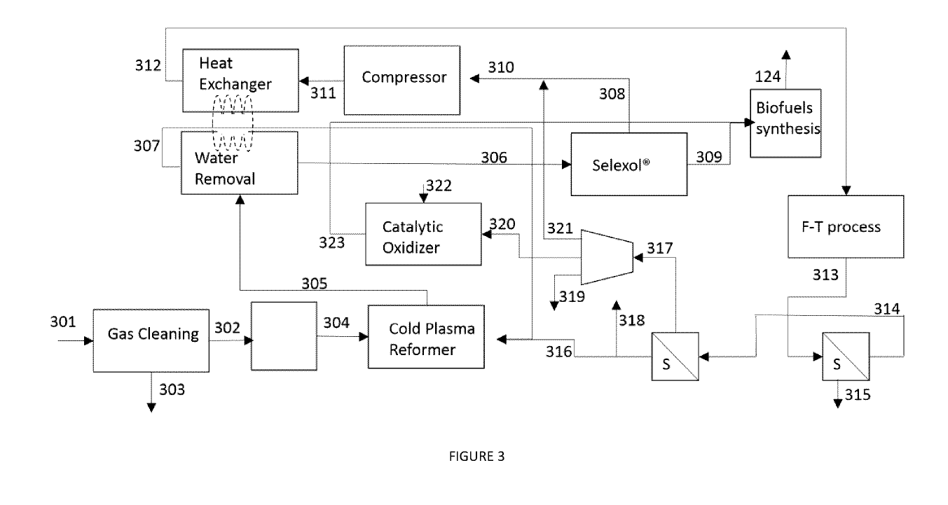

A schematic diagram for an exemplary method for producing hydrocarbon compounds is shown in FIG. 3.

A fuel stream 301 of landfill gas at 1177.17 sm³/hr comprising about 35% CO₂ and 53% CH₄ with 11% N₂ and 0.6% O₂. Methane was cleaned to produce a cleaned fuel stream 302 by removing impurities 303. Fuel stream 301 was cleaned as described in Canadian Patent Application 2,709,722 and included four steps to process the landfill gas: sulfur capture, condensing, siloxane polishing and condensate treatment. The cleaned fuel stream 302 was then compressed to 25 barg to stream 304.

Dry cleaned and compressed biogas 304 was fed into the cold plasma reformer where the methane was reformed to CO, CO₂ and H₂. Recycled aqueous stream 316 from the Fischer-Tropsch reactor, containing oxygenates (primarily methanol), was also fed into the plasma reformer. The resulting syngas 305 was produced with 95% methane conversion. The properties of the product syngas 305 are summarized in Table 7, below.

TABLE 7
Properties of Stream 305 (FIG. 3)

| | Mole fraction % | kg/hr |
|---|---|---|
| CARBON MONOXIDE | 11.56% | 667.5859 |
| CARBON DIOXIDE | 10.15% | 920.5582 |
| HYDROGEN | 20.37% | 84.01208 |
| WATER | 18.74% | 695.539 |
| NITROGEN | 38.38% | 2215.695 |
| METHANE | 0.80% | 26.3088 |
| Mass flow rate | 4609.69 | kg/hr |
| Pressure | 25 | barg |
| Temperature | 350° | C. |

The syngas 305 was then cooled to 35° C. to condense out all the water content and generate dehydrated syngas stream 306. The water stream 307 was available for recycling to the plasma reactor for the steam reforming reaction. The syngas 306 stream was then fed into the Selexol™ CO₂ removal system to produce decarbonated syngas 308 and captured CO₂ stream 309 which is utilized for biological butanol and pentanol production (stream 324) via photosynthesis using designer cyanobacteria. The Selexol™ system is capable of removing 88% of CO₂ from the gas stream and allowing a recovery of 98.7% of CO and 99.6% of H₂.

The properties of streams 306 and 308 are summarized in Table 8, below.

TABLE 8
Properties of Streams 306 and 308 (FIG. 3)

| | Stream 306 | | Stream 308 | |
|---|---|---|---|---|
| | Mole | | Mole | |
| | fraction % | kg/hr | fraction % | kg/hr |
| CARBON MONOXIDE | 14.23% | 667.59 | 15.83% | 658.91 |
| CARBON DIOXIDE | 12.49% | 920.56 | 1.69% | 110.47 |
| HYDROGEN | 25.07% | 84.01 | 28.14% | 83.68 |
| WATER | 0.00% | 0 | 0.00% | 0.00 |
| NITROGEN | 47.23% | 2215.70 | 53.23% | 2215.69 |
| METHANE | 0.98% | 26.31 | 1.11% | 26.31 |
| Mass flow rate | 3914.16 | kg/hr | 3095.54 | kg/hr |

The dehydrated and decarbonated syngas 308 was then mixed with recycled tail gas stream 321, to generate syngas mix stream 310.

Stream 310 was pressurized to 30 barg using an oil free compressor. Compressor outlet temperature was in the range of approximately 160 to 180° C. The resulting pressurized syngas 311 was further heated to approximately 200 to 220° C. (stream 312) by a shell and tube heat exchanger using the heat generated from the production of stream 306 (i.e. from condensation of water from stream 305).

The resultant pressurized and heated syngas 312 was then fed into the Fischer-Tropsch reactor. The Fischer-Tropsch reaction took place in a vertical, fixed bed, multi tubular reactor. Reactor construction was similar to a shell and tube heat exchanger. The tube side was filled with packed cobalt-based catalyst. Catalyst pellets were of trilobe construction with a diameter 0.8 mm to 1.8 mm and an aspect ratio of 2 to 3.5. The Fischer-Tropsch reaction in the tubes was extremely exothermic; 280 KW of thermal energy was generated for conversion of 65% of inlet CO to hydrocarbons. The shell side was filled with Therminol™ fluid. The composition of streams 312 and 313 from the reactor outlet are shown in Table 9, below.

TABLE 9
Properties of Stream 312 and Stream 313 (FIG. 3)

| | Stream 312 | | Stream 313 | |
|---|---|---|---|---|
| | Mole | | Mole | |
| | fraction % | kg/hr | fraction % | kg/hr |
| CARBON MONOXIDE | 12.92% | 766.17 | 2.39% | 268.16 |
| CARBON DIOXIDE | 1.98% | 184.25 | 1.05% | 184.25 |
| HYDROGEN | 21.36% | 90.49 | 2.10% | 16.81 |
| WATER | 0.00% | 0.00 | 60.37% | 316.95 |
| NITROGEN | 62.26% | 3692.82 | 32.95% | 3692.82 |
| Methane | 1.46% | 49.54 | 0.91% | 58.08 |
| Light hydrocarbons | 0.02% | 1.74 | 0.02% | 4.35 |
| Heavy hydrocarbons | 0.00% | 0.00 | 0.04% | 5.69 |
| Oxygenates | 0.00% | 0.00 | 0.17% | 238.31 |

| | | |
|---|---|---|
| Total Mass flow rate | 4785.013 kg/hr | 4785.42 |
| Liquid flow rate per day | | 3145.73 kg |
| Wax per day | | 2573.77 kg |
| Pressure (bar) | 30 | 29.89 |
| Temperature (° C.) | 204 | 212 |

Wax 315 was separated from gas stream 313 using a hot trap maintained at 220 to 180° C. The remaining gas 314 was cooled to 5-15° C. in a cold trap to condense all of the aqueous product as stream 316 and liquid hydrocarbons as stream 318. Liquid hydrocarbon product 318 was separated from the aqueous components 316 by known gravity methods.

The aqueous stream 316 contains oxygenates (primarily methanol) and H₂O, which were recycled back into cold plasma reformer for the reforming reaction. This would yield the twin benefits of decreasing the water footprint of the process, as well to decrease the water treatment required downstream of the Fischer-Tropsch process.

Remaining tail gas 317 from a cold trap contained unprocessed CO and H₂ together with small chain hydrocarbons (e.g. C1-C4), CO₂ and water. The tail gas 317 was depressurized adiabatically through a nozzle to separate out part of the CO₂ as dry ice (319) from the remaining tail gas, which was split into streams 321 and 220 in the ratio of 40:60, respectively. Stream 320 was heated using the heat from the water removal step and then oxidized with excess air (stream 322) to produce stream 323 at a temperature of 850° C. to provide auxiliary heat. The CO₂ rich stream 323 may be utilized in the production of biological butanol and pentanol (stream 324).

All documents cited or referenced herein, and all documents cited in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

The present invention has been described with regard to one or more embodiments. However, it will be apparent to persons skilled in the art that a number of variations and modifications can be made without departing from the scope of the invention as defined in the claims.

What is claimed is:

1. A method for producing hydrocarbon compounds, the method comprising:
(a) producing a syngas by introducing a fuel stream comprising a reformable fuel into a reforming system, wherein the reforming system comprises one or more of a steam reformer, an autothermal reformer, a cold plasma reformer and an internal-reforming fuel cell, and wherein the syngas comprises H₂, CO and CO₂, and has a ratio of [H₂]/[CO] of about 1.4 to about 2.5;
(b) producing a decarbonated and dehydrated syngas from the syngas by:
(bi) removing CO₂ from the syngas with a carbon capture device; and
(bii) removing water from the syngas;
wherein (bi) is prior to, simultaneous with or subsequent to (bii);
wherein the decarbonated and dehydrated syngas has a ratio of [CO₂]/[CO+CO₂] of no higher than 0.6;
(c) performing a Fischer-Tropsch synthesis on the decarbonated and dehydrated syngas under effective Fischer-Tropsch conditions in the presence of a cobalt-or iron-based Fischer-Tropsch catalyst, said Fischer-Tropsch catalyst comprising pellets of trilobe, cylindrical, hollow cylinder or spherical construction with diameter about 0.5 mm to about 3.0 mm and aspect ratio of about 1 to about 3.5, to produce a product stream comprising the hydrocarbon compounds;
(d) separating at least a portion of the hydrocarbon compounds from the product stream to further produce aqueous products and a tail gas comprising H₂, CO₂, H₂O and small chain hydrocarbons;
(e) recycling at least a portion of one or both of the aqueous products and the tail

2. The method of claim 1, wherein impurities in the fuel stream entering the reforming system are reduced by a process comprising sulfur capture, condensing, siloxane polishing and condensate treatment.

3. The method of claim 2, wherein sulfur, ammonia and chlorine present in the fuel stream entering the reforming system are each at less than 30 ppb.

4. The method of claim 1, wherein the internal-reforming fuel cell comprises a molten carbonate fuel cell (MCFC) or a solid oxide fuel cell (SOFC).

5. The method of claim 4, wherein the reforming system comprises the steam reformer, the autothermal reformer or the cold plasma reformer, in combination with the MCFC or the SOFC.

6. The method of claim 4, wherein the reforming system comprises the MCFC or the SOFC without the steam reformer, the autothermal reformer and the cold plasma reformer.

7. The method of claim 1, wherein the carbon capture device comprises: a metal oxide stabilized CaO sorbent at a temperature of about 600° C. to about 800° C.;
pressure swing adsorption; or a solvent-based absorption process.

8. The method of claim 7, wherein the metal oxide stabilized CaO sorbent comprises Zr oxide or an Al oxide.

9. The method of claim 7, wherein the carbon capture device comprises the metal oxide stabilized CaO sorbent, and wherein the method further comprises regenerating the metal oxide stabilized CaO sorbent.

10. The method of claim 9, wherein the regenerating the metal oxide stabilized CaO sorbent comprises one or both of: causing a partial vacuum in the carbon capture device using at least a portion of steam produced from the Fischer-Tropsch synthesis or at least a portion of the tail gas at high pressure; and heating and oxidizing at least a portion of the tail gas to produce auxiliary heat, and using the auxiliary heat in the regenerating of the metal oxide stabilized CaO sorbent.

11. The method of claim 1, wherein the method further comprises producing one or both of butanol and pentanol from the CO₂ removed in (bi) using bacteria.

12. The method of claim 1, wherein (bii) comprises condensing out water by cooling the syngas.

13. The method of claim 12, further comprising heating and oxidizing at least a portion of the tail gas, using heat generated from the cooling of the syngas.

14. The method of claim 12, further comprising heating the decarbonated and dehydrated syngas prior to (c) using heat generated from the cooling of the syngas.

15. The method of claim 1, further comprising compressing the decarbonated and dehydrated syngas prior to (c).

16. The method of claim 1, wherein the hydrocarbon compounds comprise liquid fuel and wax, and the method further comprises:
separating the wax from other gaseous products of the Fischer-Tropsch synthesis in a hot trap;
cooling the other gaseous products in a cold trap to condense out the aqueous products comprising water and liquid fuel from the tail gas; and
separating the liquid fuel from remaining aqueous products.

17. The method of claim 16, further comprising recycling at least a portion of the remaining aqueous products into the reforming system.

18. The method of claim 1, wherein (e) comprises adiabatically depressurizing at least a portion of the tail gas to produce liquid CO₂ and/or dry ice and cooled tail gas comprising unreacted CO and H₂.

19. The method of claim 18, wherein (e) further comprises mixing at least a portion of the cooled tail gas with the decarbonated and dehydrated syngas from (b).

20. The method of claim 18, wherein (e) further comprises using at least a portion of the cooled tail gas in as a refrigerant to cool one or both of the Fischer-Tropsch synthesis and a cold trap for cooling products downstream of (c).

21. The method of claim 1, wherein (e) comprises heating and oxidizing at least a portion of the tail gas to produce one or both of auxiliary heat, feed for the reforming system or feed for biofuel synthesis.

22. The method of claim 1, further comprising using the auxiliary heat in (bi).

23. The method of claim 1, wherein the Fischer-Tropsch catalyst is a cobalt-based Fischer-Tropsch catalyst.

24. The method of claim 1, wherein the syngas produced in (a) comprises H₂, CO and CO₂, and has a ratio of [H₂]/[CO] of about 1.4 to about 2.0.
